(19) United States
(12) Patent Application Publication
(10) Pub. No.: US 2008/0152044 A1
(43) Pub. Date: Jun. 26, 2008

(54) VETERBI DECODING METHOD FOR CONVOLUTIONALLY ENCODED SIGNAL

(75) Inventor: Kun-tso Chen, Fang-Yuan Hsiang (TW)

Correspondence Address: MADSON & AUSTIN, 15 WEST SOUTH TEMPLE, SUITE 900, SALT LAKE CITY, UT, 84101, US

(73) Assignee: Media Tek Inc., Hsin-Chu (TW)

(21) Appl. No.: 11/613,814

(22) Filed: Dec. 20, 2006

(51) Int. Cl. H04L 27/06

(52) U.S. Cl. 375/341

(57) ABSTRACT

An improved Viterbi decoding method for convolutionally encoded signals is disclosed. By using the method of the present invention, a trellis of Viterbi Algorithm (VA) for convolutionally encoded SBAS signal, for example, are arranged into butterflies. The butterflies are classified into groups according to branch metrics. Therefore, the butterflies can be effectively processed since the same butterfly processing kernel can be used repeatedly. Therefore, the code size and processing time can be reduced, so that Viterbi Algorithm can be more easily implemented by software.

### TECHNICAL FIELD OF THE INVENTION

The present invention relates to Viterbi decoding, more particularly, to a Viterbi decoding method for convolutionally encoded signals such as SBAS (Satellite Based Augmentation System) signals.

### BACKGROUND OF THE INVENTION

GNSS (Global Navigation Satellite System) applications such as GPS (Global Position System) are widely used today. For a GPS receiver, SBAS is an option under some circumstances. To decode the convolutionally encoded SBAS signal, Viterbi algorithm is used, Since SBAS data rate is low, which is 500 symbols per second, it is reasonable to use software-implemented Viterbi decoder rather than hardware-implemented Viterbi decoder to decode convolutionally encoded SBAS signals if one or two SBAS channels are to be decoded.

FIG. 1 generally shows a simple trellis of Viterbi algorithm. In the drawing, there are four states 0, 1, 2, 3 at each time point (stage). Each state is indicated by a node. To determine a survivor path (expressed by bold arrowed lines in FIG. 1), which indicates the most possible symbol sequence, an ACS (add-compare-select) unit of the Viteri decoder has to process four states in the trellis to update the survivor path at each stage. The ACS process includes “Add”, “Compare” and “Select”. “Add” is to add the branch metric to the survivor paths of the previous nodes. The branch code symbols and received symbols are used to compute a branch metric (BM) for a node. Since the computation load is very heavy, usually the computation is done in advance and a table concluded from the computation is provided for use. “Compare” is to compare the respective path metrics for the node so as to determine which path is the most possible one as a winner. “Select” is to select and store the winner as the survivor path. The branch data of the survivor path is stored. In general, a pre-prepared table is used.

For SBAS signals, whose constraint length is 7, the ACS unit must process 64 (=2⁷⁻¹) states in the trellis to update the survivor path for each state. The receiver receives tow symbols per data bit. A Branch Metric Unit (BMU) computes the branch metric for each of 128 branches. Then, the ACS unit executes “Add”, “Compare” and “Select” operations as above to select the survivor path of each node (there are 64 nodes at each stage). A Survivor Metric Unit (SMU) is used to decode the transmitted data bits by tracing back the survivor path. In the above process, if those operations are implemented by software, the computation load will be too heavy. Therefore, it is necessary to reduce code size and processing time of Viterbi Algorithm (VA) computation realized in the Viterbi decoder.

### SUMMERY OF THE INVENTION

The present invention is to provide an improved Viterbi decoding method. By using the method of the present invention, code size and processing time can be reduced, so that Viterbi Algorithm can be implemented more easily by software. Moreover, the method of the present invention reduces the complexity of the Viterbi decoder implementation and thus is more suitable for hardware implementation.

In accordance with the present invention, nodes (states) of a trellis of Viterbi Algorithm (VA) for convolutionally encoded SBAS signal, for example, are classified into several groups by a unit of a butterfly according to branch metrics. In an embodiment of the present invention, 32 butterflies for 64 states of SBAS signals for two successive stages are classified into four sub-groups. The classification for the butterflies can be used to schedule execution sequence of all the butterflies for time-division multiplexing (TDM) scheme. In addition, a butterfly processing kernel using ACS (add-compare-select) process can be used repeatedly by varying a few factors to determine a survivor for each butterfly. The factors include a specific metric defined by received symbols, Butterfly ID, and a shifting factor, which is relative to the former two.

### BRIEF DESCRIPTION OF THE DRAWINGS

The present invention will be further described in details in conjunction with the accompanying drawings.

FIG. 1 generally shows a simple trellis of Viterbi algorithm;

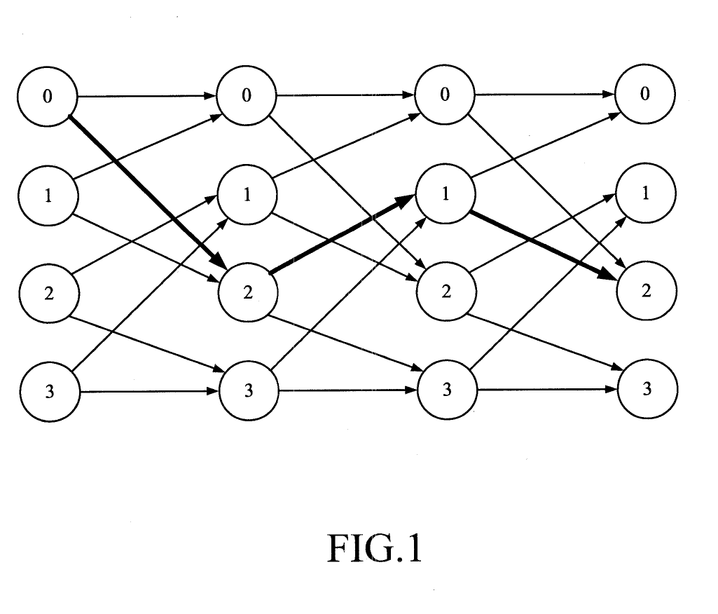

FIG. 2 illustrates a code encoder for SBAS signals;

FIG. 3 is a simplified trellis diagram for SBAS signals;

FIG. 4 shows a single generalized butterfly;

FIG. 5 shows a flow chart illustrating a main process of the Viterbi decoding method in accordance with an embodiment of the present invention at the left side, and another flow chart illustrating a sub-process of the main process at the right side; and

FIG. 6 is a flow chart illustrating a butterfly processing kernel.

### DETAILED DESCRIPTION OF THE INVENTION

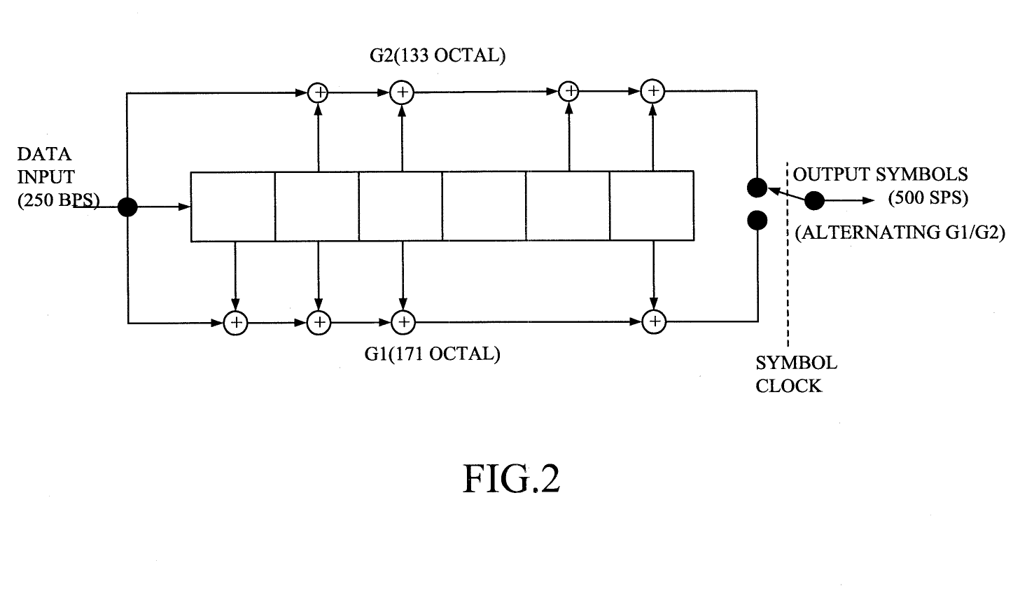

Convolution code is used in encoding SBAS signals. As mentioned, Viterbi algorithm is required for decoding convolutionally encoded SBAS signals. For each data bit of a SBAS signal, two symbols are transmitted. That is, the data rate is 0.5. FIG. 2 illustrates a code encoder for SBAS signals. As known in this field, the encoder uses polynomials G1=(171)₈ and G2=(133)₈. The constraint length of each code is 7 bits. Accordingly, there are 64 (2⁷⁻¹=2⁶=64) states for each stage. The throughput of the code generator is 250 bits per second, that is, 500 symbols per second. The node definition can be expressed as xₖ=(dₖ, xₖ₋₁⁵, xₖ₋₁⁴, xₖ₋₁³, xₖ₋₁², xₖ₋₁¹)₂.

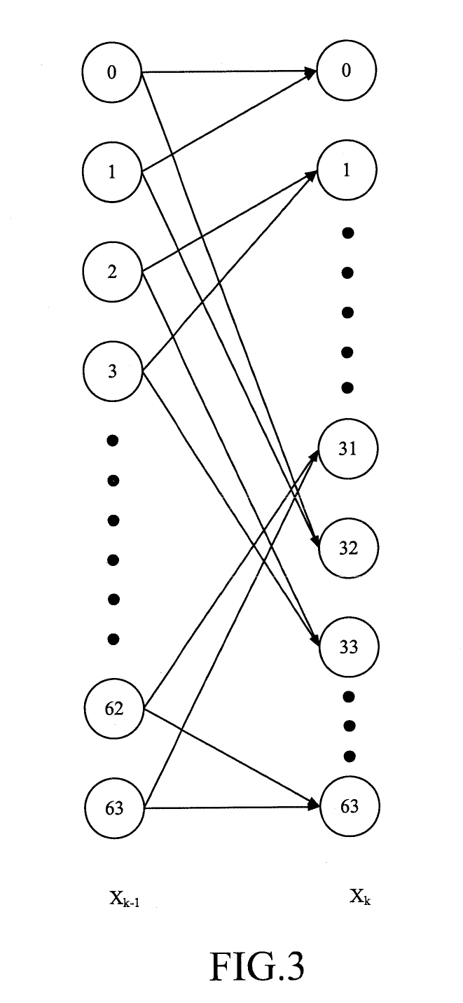

FIG. 3 is a simplified trellis diagram for SBAS signals. The drawing simply shows two stages k−1 and k. As mentioned, there are 64 states (nodes) for each stage. Each node requires one ACS process. It is more efficient to process the trellis by butterfly instead of by node. As can be seen, between two successive stages, the trellis can be arranged into 32 butterflies. For example, nodes 0 and 1 of stage xₖ₋₁ and nodes 0 and 32 of stage xₖ compose a butterfly. Similarly, nodes 2 and 3 of stage xₖ₋₁ and nodes 1 and 33 of stage xₖ compose another butterfly. By observing the trellis, it can be found that nodes 2i, 2i+1 of a source stage and nodes i, i+32 of a destination stage compose a butterfly. The indicator “i” (i=0 to 31) is referred to as Butterfly ID.

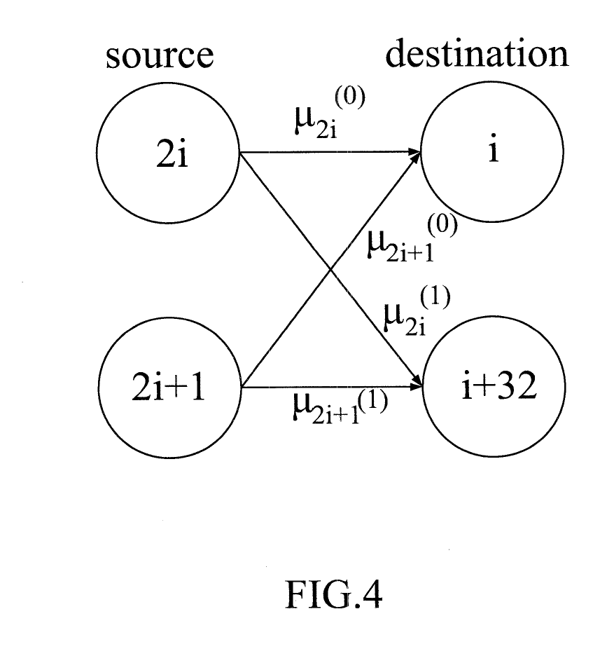

FIG. 4 shows a single butterfly, which is generalized and expressed by “i”. Assumed μ_{source node}^{(input bit)} indicates the branch metric, it can be expressed as:

μ_{source node}^{(input bit)}=r₁c₁+r₂c₂, (1)

where r₁, r₂ are the received symbols, c₁, c₂ are the branch symbols, which are derived from the code generator (G1, G2), and are +1 or −1 for SBAS signal. Then it can be deduced that:

μ₂ᵢ₊₁⁽⁰⁾=−μ₂ᵢ⁽⁰⁾=−μ (2)

μ₂ᵢ₊₁⁽¹⁾=−μ₂ᵢ⁽¹⁾=μ₂ᵢ⁽⁰⁾=μ (3)

μ₂ᵢ⁽¹⁾=−μ₂ᵢ⁽⁰⁾=−μ (4)

where μ is defined as a specific metric, which can be referred to as a butterfly metric By careful analysis, the inventor finds that the butterfly metric μ is determined by the received symbols r₁, r₂ and the butterfly ID i. The butterfly metric μ is one of four possible types of metrics depending on the butterfly ID thereof. Since the transmitted symbols c₁, c₂ are +1 or −1 for SBAS signal, then:

μ=±(r1+r2) or ±(r1−r2), depending on i(i=0 to 31) (5)

As described, the butterfly metric has four possible forms according to the Butterfly ID. That is, each butterfly has two parameters, Butterfly ID and Butterfly metric μ. Table 1 is concluded by analyzing the 32 butterflies.

TABLE 1
Possible butterfly metrics for the respective Butterfly IDs

| | Sub | | | | | | | | | |
|---|---|---|---|---|---|---|---|---|---|---|
| Gp | Gp | Metric μ | Butterfly ID i | | | | | | | |
| 0 | 0 | (r₁ + r₂) | 0 | 2 | 12 | 14 | 21 | 23 | 25 | 27 |
| | 1 | −(r₁ + r₂) | 31 | 29 | 19 | 17 | 10 | 8 | 6 | 4 |
| 1 | 0 | (r₁ − r₂) | 1 | 3 | 13 | 15 | 20 | 22 | 24 | 26 |
| | 1 | −(r₁ − r₂) | 30 | 28 | 18 | 16 | 11 | 9 | 7 | 5 |

In Table 1, “Gp” means “group”, and Sub Gp means “sub-group”. In addition, as described above, r₁, r₂ are the received symbols. The classification of the 32 butterflies shown in Table 1 can be used to schedule execution sequence of all the butterflies for a TDM (Time Division Multiplexing) sharing butterfly processor.

In accordance with the present invention, a Viterbi decoding method has a kernel, which comprises two ACS processes, to process a butterfly. Accordingly, the kernel should be executed 32 times to process the 32 butterflies. To use the same kernel to process the 32 butterflies, the branch metric required in each butterfly has to be determined.

In one embodiment of the present invention, the Viterbi decoding method determines the branch metric of the butterfly which is currently processed by Butterfly ID of the butterfly from Table 1 described above. By looking up Table 1, the branch metric can be determined as one of the four forms of branch metrics according to the Butterfly ID thereof. For example, the branch metric of the butterflies with Butterfly IDs 0, 2, 12, 14, 21, 23, 25 and 27 is (r₁+r₂), while the branch metric of the butterflies with Butterfly IDs 1, 3, 13, 15, 20, 22, 24 and 26 is (r₁−r₂). Alternatively, some parameters can be used to determine sub-group that the butterfly to be processed belongs to, and the branch metric thereof can be determined accordingly. The details will be described later.

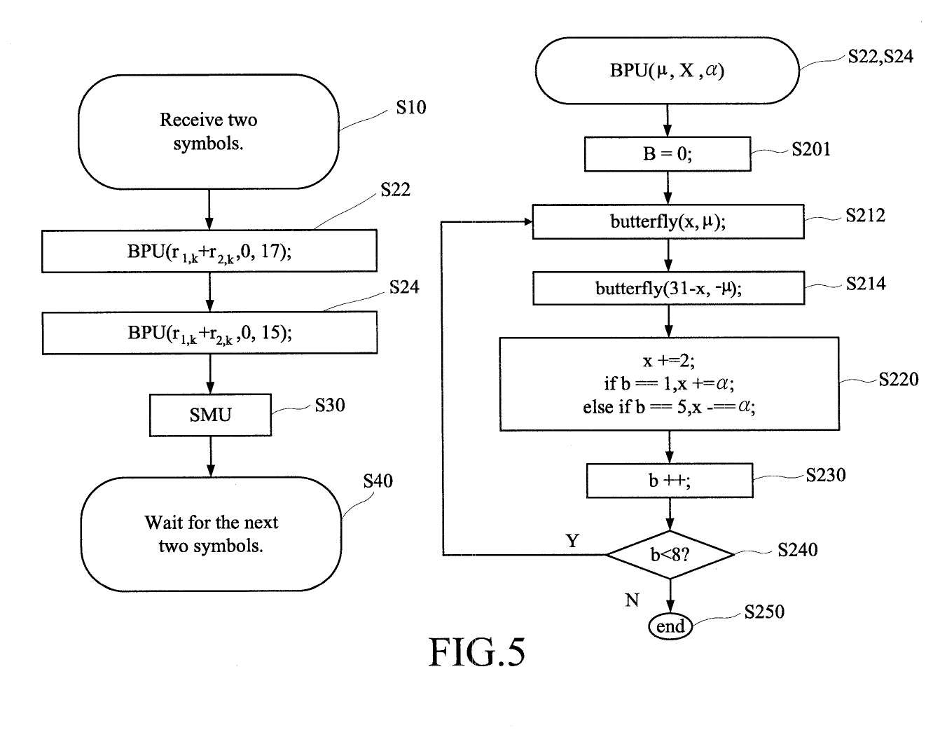

By analyzing Table 1, a process for determining the branch metric of each butterfly can be obtained. FIG. 5 shows a flow chart illustrating a main process of the Viterbi decoding method in accordance with the present embodiment of the present invention at the left side, and another flow chart illustrating a sub-process of the main process at the right side. The main process is described at first. In step S10, the Viterbi decoder receives two symbols. Steps S22, S24 respectively indicate a sub-process for processing butterflies of Group 0 (including 16 butterflies) and Group 1 (including 16 butterflies). In step S22, the first value of a butterfly ID indicator “x” is “0”, that is x=0, and the value of a shifting factor α is “17”; while in step S24, the first value of the butterfly ID indicator “x” is “1”, that is x=1, and the value of the factor α is “15”, the details will be further described later. After the 32 butterflies (64 nodes) have been processed, that is, the branch metric of each butterfly has been determined, then a survivor path is determined, and the transmitted data bit sequence (two symbols compose a data bit) is decoded in step S30. In the drawing, step S30 is simply expressed SMW (Survivor Metric Unit), since the operations executed in this step are the same as those executed by the SMU of the Viterbi decoder.

The sub-process will be described now. The sub-process is adaptable for Group 0 (step S22) and Group 1 (step S24). To determine the metric for the butterfly to be processed, three factors are used in the present embodiment. The three factors include the specific metric (butterfly metric) μ, Butterfly ID indicator x and shifting factor α. The butterfly metric μ is (r₁+r₂) and α is 17 for Group 0, while μ is (r₁−r₂) and α is 15 for Group 1. The function is expressed as BPU (μ, x, α) in the flow chart (S22, S24). In step S201, a butterfly processing number “b” indicating the times that a butterfly processing kernel has been executed is initialized as zero (b=0). The Butterfly ID indicator x can be chosen arbitrarily from 0 to 31. If x=0, a butterfly processing kernel is executed for Butterfly ID=0 in step S212. In addition, the butterfly processing kernel is also executed for Butterfly ID=31−x=31−0=31 in step S214. For butterflies with ID=x, the branch metric is μ; for butterflies with ID=31−x, the branch metric is −μ. In step S220, x is added with 2, that is, x=x+2. If b is 1, then x is further added with α, that is x=x+2+α. If b is 5, x is subtracted with a, that is x=x+2−α. In the case that x=0, the updated x is x=0+2=2. In step S230, b is added with 1, that is, b=b+1. In step S240, it is determined whether b<8. If so, the process returns to steps S212 and S214; if not, the sub-process ends. In other words, for each of Group 0 and Group 1, the sub-process is run for 8 times (b=0 to 7) for Butterfly ID x and Butterfly ID 31−x, respectively. Table 2 shows relationship between b and x for the case that Butterfly ID=x, the shifting factor a is also considered as described above

TABLE 2
Relationship between b and x for the case that Butterfly ID = x.

| | | | | | | | | |
|---|---|---|---|---|---|---|---|---|
| b | 0 | 1 | 2 | 3 | 4 | 5 | 6 | 7 |
| x | 0 | 2 | 21 | 23 | 25 | 27 | 12 | 14 |
| α | | | + | | | − | | |

### The relationship between b and x for the case that Butterfly ID=31−x can be deduced similarly.

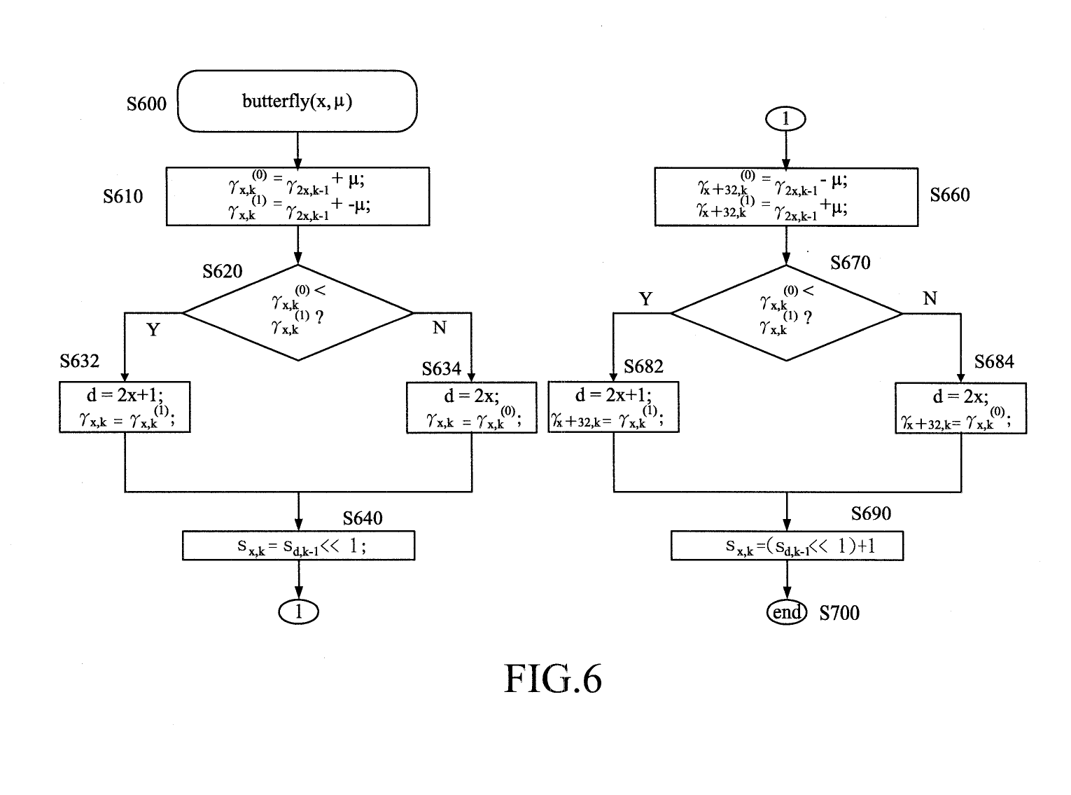

FIG. 6 is a flow chart illustrating a butterfly processing kernel. The kernel starts from step S600. Butterfly (x, μ) (FIG. 5, Step S212) is described as an example. Please also refer to FIG. 4. In step S610, the possible destination node metric β_{x,k}⁽⁰⁾, γ_{x,k}⁽¹⁾ are respectively computing by adding the source node metric γ_{2x, k-1}⁽⁰⁾, γ_{2x+1, k-1}⁽¹⁾ with the branch metrics expressed by μ(+μ, −μ) This step is known as “Add”. Then, in step S620, the two possible destination metrics γ_{x,k}⁽⁰⁾, γ_{x,k}⁽¹⁾ are compared. This is known as “Compare”. If γ_{x,k}⁽⁰⁾<γ_{x,k}⁽¹⁾, then a source node indicator d=2x+1, that is, the branch metric is selected as γ_{x,k}=γ_{x,k}⁽¹⁾. If γ_{x,k}⁽⁰⁾>γ_{x,k}⁽¹⁾, then the source node indicator d=2x, that is, the branch metric is selected as γ_{x,k}=γ_{x,k}⁽⁰⁾. This is known as “Select”. Then, the data bit sequence s_{x,k} output from the code generator shown in FIG. 2 should be the last code s_{d,k-1} shifted by one bit, and the empty bit space at the left most is filled with “0” (step S640). The steps S610 to S640 described above are for the upper branch (see FIG. 4). In this flow chart, steps S660 to S690 are for the lower branch, which are similar to those for the upper branch, and can be easily deduced from the above descriptions. Therefore the descriptions thereof are omitted herein. It is noted that the data bit sequence s_{x,k} for the lower branch output from the code generator shown in FIG. 2 should be the last code s_{d,k-1} shifted by one bit, in addition, the empty bit space at the left most is added with “1”. The sub-process ends in step S700. The butterfly processing kernel includes two ACS processes described above.

By analyzing the butterflies for all states of the trellis of Viterbi Algorithm (VA) for convolutionally encoded SBAS signals, the analyzed results can be generalized into a table (e.g. Table 1) or simple rules depending on a few variables (e.g. μ, x, α mentioned with reference to the flow chart of FIG. 5). Accordingly, the butterfly processing kernel can be repeatedly used for 32 SBAS butterflies, for example. Therefore, the code size and also the processing time of the Viterbi decoding method in accordance with the present invention can be reduced. Although SBAS signals are described as an example, the Viterbi decoding method of the present invention can also be applied to any other proper convolutionally encoded signals.

While the preferred embodiment of the present invention has been illustrated and described in details, various modifications and alterations can be made by persons skilled in this art. The embodiment of the present invention is therefore described in as an illustrative but not in a restrictive sense. It is intended that the present invention should not be limited to the particular forms as illustrated, and that all modifications and alterations which maintain the spirit and realm of the present invention are within the scope as defined in the appended claims.

What is claimed is:

1. A Viterbi decoding method for convolutionally encoded signals, all nodes of each stage of a trellis in Viterbi Algorithm used in said method being deduced into butterflies, each butterfly having a specific butterfly ID and including two source nodes and two destination nodes, said method comprising:
receiving symbols composing a data bit;
defining branch metrics for each destination node of each butterfly with the received symbols and branch symbols; and
classifying all the butterflies according to the defined branch metrics.

2. The method of claim 1, further comprising executing a butterfly processing kernel to select survivors for each butterfly by using the defined branch metrics.

3. The method of claim 2, wherein the butterfly processing kernel comprises adding a corresponding one of the defined branch metrics to node metric of each of the source nodes to obtain a destination node metric for the butterfly, comparing the destination node metrics, and selecting the most possible destination node metrics as a survivor.

4. The method of claim 3, further comprising decoding the survivor.

5. The method of claim 2, wherein a butterfly to be processed is selected according to the butterfly ID of the previously processed butterfly and relationship between butterfly IDs and branch metrics.

6. The method of claim 5, wherein the butterfly to be processed is selected farther according to the times that the butterfly processing has been executed.

7. The method of claim 1, wherein the butterflies are classified into groups by butterfly IDs.

8. The method of claim 1, wherein the convolutionally encoded signals comprises SBAS signals.
